(19) United States
(12) Patent Application Publication
(10) Pub. No.: US 2009/0092339 A1
(43) Pub. Date: Apr. 9, 2009

(54) Viewing and Scanning of Microfilm Using a Self-Contained Digital Device Without a Personal Computer

(76) Inventors: Thomas P Anderson, JR., Lake Forest, IL (US); Daniel J. Donaldson, Sicklerville, NJ (US)

Correspondence Address: COOK ALEX LTD, SUITE 2850, 200 WEST ADAMS STREET, CHICAGO, IL, 60606, US

(21) Appl. No.: 11/866,496

(22) Filed: Oct. 3, 2007

(51) Int. Cl. G06K 9/60

(52) U.S. Cl. 382/305

(57) ABSTRACT

Apparatus for, and methods of, capturing and storing images in a self-contained digital microfilm scanning system without requiring a personal computer or software. A digital microfilm scanner captures an image from microfilm and sends the captured image directly from the digital scanner to a viewing device for displaying the captured image. The digital microfilm scanner also sends the captured image directly to a memory storage device, such as a memory card of the SD type with a USB connector. The captured images may then be transferred to a personal computer with a compatible port or printed by a printer with a compatible port.

### FIELD OF THE INVENTION

The present invention relates generally to methods and apparatus for viewing and scanning digital images from microfilm without any need for the imaging device to be operated from or with a personal computer.

### BACKGROUND OF THE INVENTION

Collections and libraries of images and documents exist on microfilm in many locations throughout the world. Many documents and other images have been placed on microfilm over the past several decades. In many instances, certain documents may only be available from microfilm. The microfilm media may be in various forms including cartridges, rolls and microfiche cards. For example, documents in the typical 8 inch by 11½ inch page format are frequently stored on 16 mm cartridges. Newspapers and genealogy records are typically stored on 35 mm media. Content and indexes to collections may also be on microfiche cards. Existing microfilm readers typically accommodate many or all of these different microfilm formats.

Often such microfilm collections are housed at significant distances from researchers or other individuals who would like to view the content and to copy or make use of it. In addition to the distances between the microfilm and the viewers, copyright issues may exist. The cost of duplicating any microfilm collection may also be prohibitive or impractical due to the millions of images that may exist on hundreds or thousands of rolls of film or microfiche cards. Many of the same factors also make digitization of microfilm collections impractical and unduly expensive.

In addition, manual handling of microfilm by trained handlers is frequently preferred by the owners of microfilm collections. This is because there is less theft of the microfilm, there is less misfiling of the microfilm after use, unauthorized duplication can be avoided, unauthorized access or viewing can be controlled, and copyright issues can be minimized. Researchers or users of microfilm content therefore must usually appear at the location of the microfilm collection in order to review it. Some owners of microfilm collections regularly make and sell copies of images upon receiving orders.

In 2004, ST Imaging, a subsidiary of Digital Check Corporation, the assignee of the present invention, introduced the first all-digital microfilm scanning system under the model number ST200. For example, the ST200 system includes a digital video camera device, a high resolution line scanner, and a method to hold and advance film media. This device is attached to a digital monitor, a personal computer and a keyboard. This ST200 system was designed to meet the requirements of larger users of microfilm scanning equipment, such as libraries. The ST200 system provided superior digital reliability and quality. The ST200 system also provides the advantages of viewing and capturing images on all types of film and opaque media without the need to change lenses or carriers, as in the traditional prior art microfilm readers and printers.

More recently, ST Imaging introduced a new remote film access system which enables viewing and searching through rolls of microfilm via the internet. The remote film access system provides control of a remotely located digital microfilm scanner from a remotely located user's computer. This remote film access system requires a computer at the location of the digital microfilm scanner, such as at a library where the microfilm is located. The computer at the library gathers images from the microfilm scanner and transmits the images over the internet to the user's remotely located computer. The computer at the library also provides an interface for controlling the digital scanner from the user's remotely located computer. For example, the remote user may be able to remotely control many scanning functions such as forward film movement, fast forward film movement, reverse film movement, fast reverse film movement and stop film movement. In addition, the remote user may also control zoom in, zoom out, near focus, far focus, auto-focus, iris normal, iris open and iris closed functions of the microfilm scanner. Thus, the user can remotely obtain and download images of the microfilm. Once the desired images are downloaded, the user can print the images at his/her computer. Obviously, such a remote film access system also requires a computer to pass the scanning commands from the remote user to the digital microfilm scanner, and to communicate the scanned images from the scanner to the user's computer.

Such digital microfilm scanning developments have satisfied needs for digital scanners and for remotely reviewing and capturing images from microfilm. However, some patrons of libraries find computer-based systems more complex and daunting to use. Also, libraries typically have limited budgets. There is therefore a need for replicating the advantages of the digital film equipment in a self-contained device that is simpler to operate. There is also the need to accomplish this objective without increasing expensive computer networks, hardware, software and/or infrastructure resources.

A general object of the present invention is to therefore provide a simpler and self-contained digital viewing and scanning device which does not require a separate personal computer and which does not require the operator to run computer software to operate the system.

Another object of the present invention is to provide digital microfilm scanning equipment which occupies less space, and therefore can be operated from smaller work areas.

A further object of the present invention is to provide digital microfilm scanning equipment which does not require a personal computer.

Yet another object of the present invention is to provide digital microfilm scanning equipment which transfers desired digital images directly to a digital memory media.

A still further object of the present invention is to provide digital microfilm scanning equipment which transfers desired digital images directly to a Secure Digital (SD) memory card, or the like.

### SUMMARY OF THE INVENTION

The present invention is directed to methods and apparatus for viewing and scanning digital images from microfilm without any need for the imaging device to be operated from or with a personal computer. A digital microfilm scanning system includes a digital microfilm scanner for capturing an image from microfilm, a viewing device for directly receiving the captured image from the digital microfilm scanner, and for displaying the captured image, and a memory storage device for directly receiving and storing the captured image from the digital microfilm scanner. A port may be disposed in a printer for receiving the memory storage device and for printing previously captured images from the printer. The memory storage device may be a memory card, such as of the SD card type or the SD Plus USE card type.

The present invention also includes methods of capturing and storing images in a digital microfilm scanning system. Typical steps of the methods include capturing an image from microfilm with a digital microfilm scanner, sending the captured image directly from the digital scanner to a viewing device for displaying the captured image, and storing in the memory storage device. Further steps may include receiving the memory storage device in a port of a printer, receiving the captured image at the printer and printing the captured image by the printer.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is a perspective view of a microfilm viewing and scanning system in accordance with the present invention; and

FIGS. 2A and 2B are perspective views of a memory card of the SD type which may be configured for connection to connectors of the universal serial bus (USB) type.

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

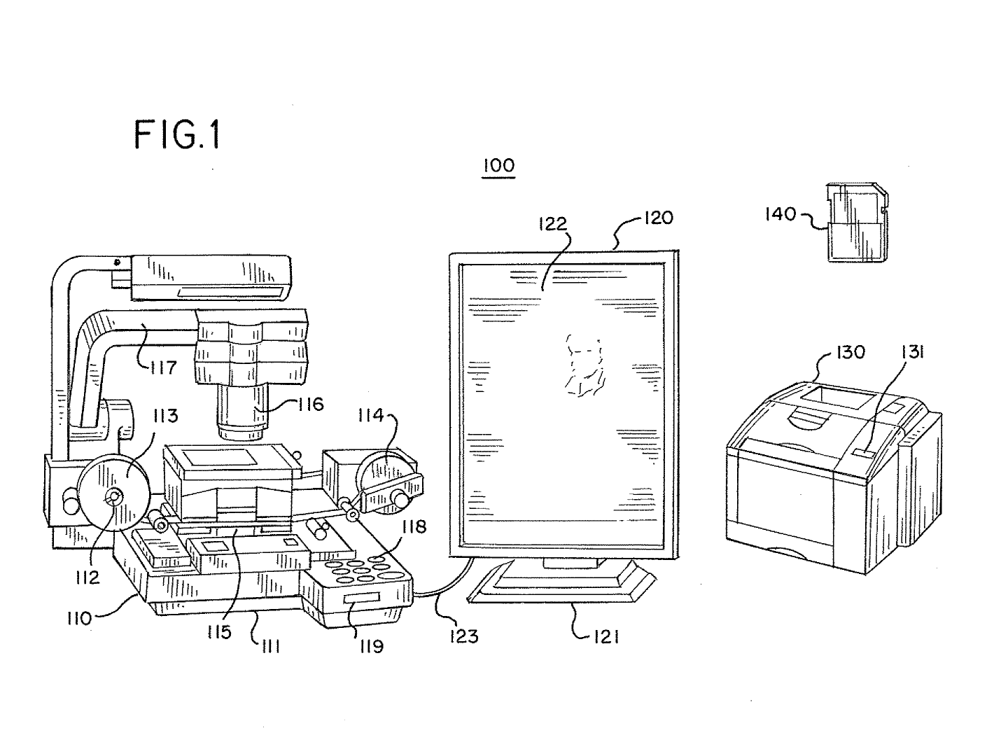

FIG. 1 illustrates a digital microfilm viewing and scanning system, generally designated 100, for digitally viewing and scanning a microfilm medium in accordance with the present invention. Microfilm viewing and scanning system 100 typically includes a digital microfilm scanner 110, a viewing device 120 and a printer 130. Viewing device 120 is typically used for viewing of an image scanned by scanner 110. Both scanner 110 and viewing device 120 each have a base 111 and 121, respectively, for placement of scanner 110 and viewing device 120 on a desk, table or the like. On one side of scanner 110, a roll of microfilm 113 may be mounted on a spindle 112. The microfilm on roll 113 is then threaded through a viewing area 115 to a take-up reel 114, which is located on the opposite side of scanner 110. The user can then move the film from one image to the next by pushing a button or by turning a knob on the take-up reel to move the film across the viewing area 115. In a known manner, a source of illumination may be provided below the viewing area 115 to provide backlighting for viewing of the microfilm. Preferably, take-up reel 114 is motorized for fast forwarding of the microfilm and spindle 112 is also motorized for fast rewinding of the microfilm, such as when viewing is finished.

A digital camera 116 takes images of the microfilm. The digital camera is mounted to the base 111 of scanner 110 by an adjustable and extensible arm 117. A plurality of controls 118 is provided for operation of the scanner 110. For example, controls 118 may include zoom, pan, rotate, invert and focus of the film images. Preferably, digital scanner 110 may also invert negative images, electronically zoom, rotate images, automatically focus, and digitally remove any scratches from the image.

Different embodiments of viewing device 120 may be used with scanner 110. However, the viewing device 120 is preferably a stand-alone display monitor or viewing screen, such as of the liquid crystal display (LCD) type, or the like, with a suitable display or viewing screen 122. Such displays 122 are commercially available from a number of vendors including Dell Inc. of Round Rock, Tex. and Hewlett-Packard Corporation of Palo Alto, Calif. Scanner 110 is preferably equipped with a connector to provide a direct video signal via a cable 123 to a video connector on the viewing device 120, without the need for, or intervention of, a personal computer or the like.

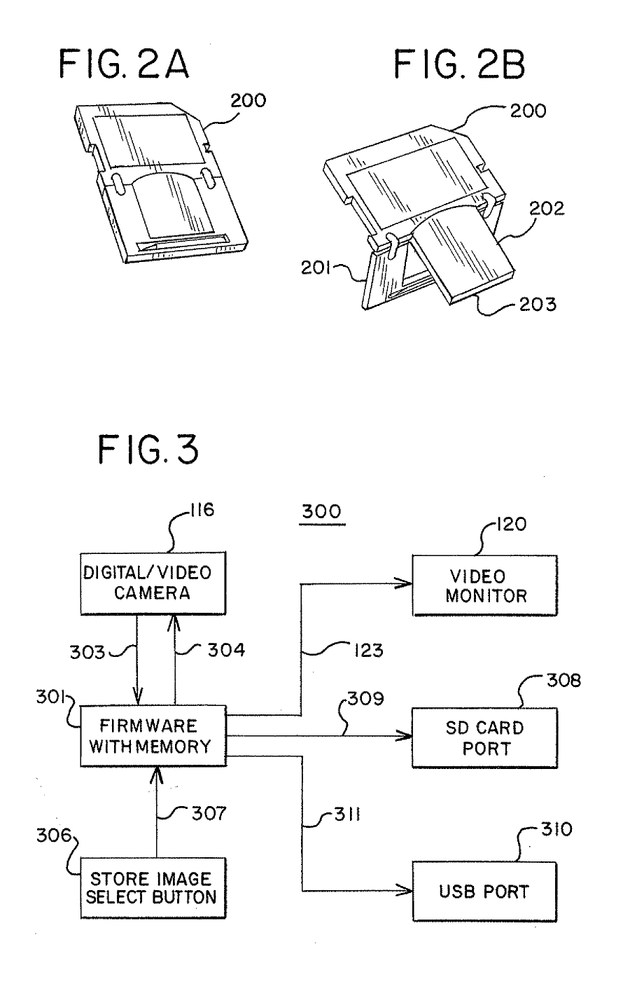

An optional printer 130 receives digital information related to the image via a port 131 which may be suitable for receiving a memory storage device 140 in FIG. 1 or a memory storage device 200 in FIGS. 2A and 2B. Memory device 200, which has both an SD card connector and a USB connector, is described in further detail below. Virtually all current personal computers, laptop computers and printers, especially printers suitable for printing pictures, have at least one port suitable for receiving an SD card memory device or have a USB connector. More recent printers, especially printers suitable for printing pictures, have such a port 131. For example, such printers are commercially available from the Hewlett-Packard Corporation of Palo Alto, Calif.

For example, memory storage device 140 may be of the type commonly used in cameras, such as an SD memory card which is commercially available from the SanDisk Corporation of Milpitas, Calif., or the like. When memory storage device 140 is installed in port 131 of printer 130, a copy of each video image captured by scanner 110 can be printed. The user may then remove memory storage device 140 from port 131 when he/she has completed the microfilm scan printing session. The user may then print out the images stored on memory storage device 140 at any compatible printer or computer. Of course, more recent computers, such as laptops, come equipped with a port for receiving an SD memory storage device, and virtually all such models also have USB input capability.

FIGS. 2A and 2B illustrate another embodiment of a memory storage device 200 suitable for use in the present invention. Memory storage device 200 functions as an SD memory card in the configuration shown in FIG. 2A. However, as shown in FIG. 2B, a lower portion 201 of memory card 200 may be snapped or bent away from a lower center portion 202 to provide a connector 203 of the universal serial bus (USE) type for the memory card 200 suitable for insertion into a mating USB connector. Thus, memory card 200 greater versatility since it may be used in either a connector suitable for receiving an SD card, or in commonly provided USE connectors, such as in either digital scanner 110 or in printer 130. Memory card 200 is commercially available from the SanDisk Corporation as the Ultra SD Plus USB card.

Scanner 110 may be provided with a port 119 for receiving a memory storage device 140, such as the SD card 140 or the dual purpose SD card 200 with the USB connector. One of controls 118 may then be actuated to store selected images captured by scanner 110 on the memory storage device 140.

A block diagram 300 in FIG. 3 provides an example of storing a captured microfilm image by inserting the SD card 140 into an SD card port 308 or by inserting the USE compatible SD card 200 into a USB port 310. It will be understood that port 119 in FIG. 1 may be either an SD port 308 or a USB port 310, or that multiple ports 119 may be provided on scanner 110 with at least one port of the SD type and at least one port of the USB type.

Camera 116 may be a digital camera or a video camera. If it is a video camera, it preferably has the capability of taking still images of the microfilm. Camera 116 provides a captured microfilm image on a line 303 to a firmware with memory 301, where the captured image may be temporarily stored. The firmware 301 also provides signals to camera 116 on a line 304. These signals may be for various camera control functions, such as focus, auto-focus, zoom, and the like. Firmware 301 also supplies current image information to the video monitor or display 120 on line 123. Firmware 301 preferably resides in scanner 100. It need not be as complex as a self-contained personal computer, but may be a microprocessor or microcontroller or suitable control and memory circuitry.

When a user of scanner 100 wishes to store a captured image at either SD card port 308 or at USB port 310, the user activates a store image select button 306. Button 306 may be disposes among the other plurality of controls 118 shown in FIG. 1, or it may be on a handheld remote control or the like. When firmware 301 detects the storage command from button 306, it sends the captured image to port 308, port 310, or both, for storage in the memory card 140 or 200 in either or both ports. Of course, since port 310 is of the USB type, it may also utilize other types of USB-compatible memory such as a thumb memory, or the like. After the captured image(s) are stored on the memory card, the user may later print the images at a printer 130 which has a compatible SD or USB port, or transfer the images to a personal computer or laptop computer, or the like.

It will be noted that the microfilm imaging system 100 is implemented without a separate computer, such as a personal computer. System 100 thus provides a cost-effective way of replacing older microfilm reader-printers. Many microfilm reading and research areas often include one or two personal computer workstations with old microfilm readers and microfilm reader-printers. Adding digital microfilm scanners, which incorporate computers, typically requires adding new wiring or nodes, wireless repeaters, routers, seat licenses, personal computer equipment, and desktop and network software. In addition, the costs of supporting such installations can also be expensive. However, by deploying computer-less digital scanning systems 100, the initial costs and ongoing costs of additional personal computers are eliminated. There is no need for software upgrades or operating system upgrades. In addition, there are no computer viruses to contend with.

However, if desired, two or more digital microfilm scanning systems 100 can be networked by a personal computer. One such example is for networking multiple microfilm scanning systems 100 to a single pay-for-print system to support all printing requirements. Another example is to provide additional image scanning and editing features with ScanWrite™ software, which is used to capture images and then send the images to a compact disk (CD), to a flash drive, to network storage, or as an email attachment.

While particular embodiments of the invention have been shown and described, it will be obvious to those skilled in the art that changes and modifications may be made therein without departing from the invention in its broader aspects.

1. A digital microfilm scanning system, said scanning system comprising:
a digital microfilm scanner for capturing an image from microfilm;
a viewing device for directly receiving the captured image from the digital microfilm scanner, and for displaying the captured image; and
a memory storage device for receiving and storing the captured image from the digital microfilm scanner and for storing the image in the memory storage device.

2. The digital microfilm scanning system in accordance with claim 1, said scanning system further comprising:
a printer, said printer having a port for receiving said memory storage device and for receiving at least one captured image for printing of the capture image.

3. The digital microfilm scanning system in accordance with claim 2, wherein said memory device is of the SD card type and said port in the printer is of the SD card type.

4. The digital microfilm scanning system in accordance with claim 2, wherein said memory device is of the SD card type and said port in the printer is of the SD card type with a USB connector.

5. The digital microfilm scanning system in accordance with claim 2, wherein the memory storage device has a USB connector and said printer has a USB connector for receiving the memory storage device.

6. The digital microfilm scanning system in accordance with claim 1, said scanning system further comprising:
a port disposed in said digital microfilm scanner for receiving a memory storage device;
said memory storage device for receiving captured images and for storing the captured images.

7. The digital microfilm scanning system in accordance with claim 6, wherein the memory storage device is a memory card.

8. The digital microfilm scanning system in accordance with claim 7, wherein the memory card is of the SD type.

9. The digital microfilm scanning system in accordance with claim 8, wherein the memory card is of the SD type with a USB connector.

10. A method of capturing and storing images in a digital microfilm scanning system, said method comprising the steps of:
capturing an image from microfilm with a digital microfilm scanner;
sending the captured image directly from the digital scanner to a viewing device for displaying the captured image;
sending the captured image from the digital scanner to a memory storage device; and
storing the captured image in the memory storage device.

11. The method of capturing and storing images in a digital microfilm scanning system in accordance with claim 10, said method comprising the further steps of:
receiving the memory storage device in a port of a printer;
receiving captured images by the printer from the memory storage device; and
printing of the captured image by the printer.

12. The method of capturing and storing images in a digital microfilm scanning system in accordance with claim 10, wherein the memory storage device is a memory card.

13. The method of capturing and storing images in a digital microfilm scanning system in accordance with claim 12, wherein the memory storage device is a memory card is of the SD type.

14. The method of capturing and storing images in a digital microfilm scanning system in accordance with claim 10, wherein the memory storage device is a memory card is of the SD type with a USB connector.

15. The method of capturing and storing images in a digital microfilm scanning system in accordance with claim 10, wherein said digital microfilm scanner has a port for receiving a memory storage device, said method comprising the further step of:
receiving the memory storage device in a port disposed in the digital microfilm scanner.

16. The method of capturing and storing images in a digital microfilm scanning system in accordance with claim 15, wherein the memory storage device is a memory card.

17. The method of capturing and storing images in a digital microfilm scanning system in accordance with claim 16, wherein the memory storage device is a memory card is of the SD type.

18. The method of capturing and storing images in a digital microfilm scanning system in accordance with claim 17, wherein the memory storage device is a memory card is of the SD type with a USB connector.
